(19) United States
(12) Patent Application Publication
(10) Pub. No.: US 2008/0221328 A1
(43) Pub. Date: Sep. 11, 2008

(54) LUMINESCENT LANTHANIDE COMPLEXES

(76) Inventors: Jan Reedijk, Leiden (NL); Wen Tian Fu, Oegstgeest (NL); Patrick Gamez-Enamorado, Den Haag (NL); Tiddo J. Mooibroek, Lieden (NL)

Correspondence Address: INTELLECTUAL PROPERTY / TECHNOLOGY LAW, PO BOX 14329, RESEARCH TRIANGLE PARK, NC, 27709, US

(21) Appl. No.: 12/041,338

(22) Filed: Mar. 3, 2008

Related U.S. Application Data
(60) Provisional application No. 60/904,969, filed on Mar. 5, 2007.

(51) Int. Cl. C07F 19/00

(52) U.S. Cl. 546/5

(57) ABSTRACT

Neutral lanthanide(III) complexes including at least one ligand are disclosed. The ligand includes a heterocyclic aromatic ring with at least one carboxylic acid group attached thereto, wherein a heteroatom of the heterocyclic ring and the carboxylate function of the carboxylic acid group co-ordinate (chelate) to the lanthanide. The complexes can be used in luminescent lamps and luminescent displays. The complexes can be synthesized by heating a mixture of a lanthanide 3+ salt and ligand L in a suitable solvent until a precipitate of the lanthanide complex forms. In one embodiment, the formal 3+ charge on the lanthanide is neutralized by providing in the ligands for the complex, three coordinating carboxylate groups, (RCO₂⁻). The heteroatom coordinated to the lanthanide may be nitrogen, oxygen, sulfur or phosphorus.

### FIELD OF THE INVENTION

The present invention relates to luminescent lanthanide complexes, which exhibit luminescence in the visible light region when excited by ultra violet light. It includes methods for their manufacture and their use in lighting and display device applications.

### BACKGROUND TO THE INVENTION

Rare earth-based luminescent materials have found many applications in today's lighting and display technologies. A well-known example is the field of luminescent lamps. In such devices, ultraviolet radiation from low-pressure mercury plasma is converted into visible light by a phosphor layer deposited on the inner side of the lamp tube. Luminescent lamps have very high-energy conversion efficiency, which is about eight times as high as that of incandescent lamps^{1,2}.

Rare earth-activated phosphors possess superior properties in comparison with traditional halo-phosphate-based phosphors such as (Ca₅(PO₄)₃(F,Cl):Sb,Mn). In so-called tricolor luminescent lamps, a mixture of three rare earth-activated phosphors, which emit narrow bands of radiation with emission maxima close to 450 (blue), 540 (green) and 610 nm (red) respectively, are employed to produce a white light. Such a lamp achieves a combination of high efficiency (˜100 lm W⁻¹) with a high color-rendering index (CRI) (˜85). The materials that are currently used in industry are listed below^{2,3}:

| | | | | Lumen |
|---|---|---|---|---|
| | λ_{max.} | Absorption | Quantum | equivalent |
| Chemical composition | (emi.) | at 254 nm | efficiency | (lm W⁻¹) |
| BaMgAl₁₀O₁₇:Eu²⁺ | 450 | 90 | >90 | 90 |
| (blue) | | | | |
| Sr₅(PO₄)₃Cl:Eu²⁺ (blue) | 450 | 90 | >90 | 90 |
| CeMgAl₁₁O₁₉:Tb³⁺ | 541 | 95 | 85 (5)* | 490 |
| (Green) | | | | |
| (Ce,Gd)MgB₅O₁₀:Tb³⁺ | 542 | 95 | 88 (2)* | 495 |
| (Green) | | | | |
| (La,Ce)PO₄:Tb³⁺ | 545 | 95 | 86 (7)* | 500 |
| (Green) | | | | |
| Y₂O₃:Eu³⁺ (Red) | 611 | 75 | ~97 | 280 |

*Values in parentheses are the quantum efficiency of the UV-emission of Ce³⁺.

From the above list, it can be seen that the phosphors used in current tricolor lamps are all oxide-based materials. Although these materials have reached high quantum efficiency and show good UV absorption and excellent stability, they are relatively expensive. The cost represents a limiting factor to the replacement of the traditional halo-phosphate-based materials, which, even today, still have a considerable market share.

A more economic use of the rare earth-activated phosphors can be achieved in different ways. The concentration of the activators in the material can be reduced or the host material of red phosphor material can be substituted with an alternative, because of the high price of Eu—, Tb— and Y-oxide. However, this approach results in a decrease of the efficiency of the luminescence. An alternative route to reducing price would be to decrease the manufacturing costs. Since these oxides have very high melting points, the preparation temperature is high, typically at above about 1500° C., resulting in an expensive manufacturing process. A particularly preferred method of reducing cost would be the recycling of the expensive rare earths. Unfortunately, due to the relatively complicated chemical processes to regenerate them, rare earth-activated phosphors are not usually been recycled.

Lanthanide complexes, rather than oxide materials have long been known to be luminescent with characteristic visible light emissions of each rare earth activator. This type of material is of particular interest for the following reasons:
Unlike the oxide-based phosphors in which the efficient absorption is either via charge transfer (e.g. Y₂O₃:Eu) or via the allowed 4f→5d transition of sensitizers (e.g. Ce in CeMgAl₁₁O₁₉:Tb³⁺), luminescence in a lanthanide complex is via the so-called “antenna” mechanism. The incident energy is absorbed by ligand and then transferred to the luminescent centers. Since the transition from ground state to excited singlet is allowed, in these complexes, the absorption of UV radiation is highly efficient, and is generally better than for oxide materials.
It is, in principle, easy to modify the ligand, and, thus, to control the luminescent properties of the complex; this is difficult to achieve in inorganic oxides.
Many ligands are commercially available and are relatively cheap materials. In addition, the preparation of complexes can be carried out at much lower temperatures, usually less than 200° C. These can significantly reduce the production costs.
Complexes are molecular-based solid materials. Therefore they do not require highly pure rare earths as starting materials in order to be able to manufacture effective products, unlike the known oxide materials.
As the luminescence behaviour results from processes that are essentially intermolecular, it is, in principle, possible to manufacture materials that contain more than one luminescent centre, or rare earth ion, e.g. Eu³⁺ and Tb³⁺. The “colour” of the emission of a material can be changed by simply adjusting the relative concentration of different luminescent ions during the manufacture of the product.
Recycling the expensive rare earths can be readily achieved from complexes, e.g. by dissolution in inorganic acids or by burning, which ensures an economic use of these elements.

Despite the various potential advantages, rare earth (lanthanide) complexes have received less attention in the field of lighting and display applications. This is mainly due to the low luminescent efficiency of the known complexes, in comparison with oxide-based luminescent materials. Another reason is that the synthesis of lanthanide coordination compounds is often quite demanding. They tend to be unstable in the presence of moisture, subject to photochemical degradation and sometimes oxidation. Consequently, interest in lanthanide complexes to date has been largely focused on their use as luminescent probes in special fields such as bio-analysis.

It is an object of the present invention to provide luminescent lanthanide complexes that avoid or at least minimize one or more of the aforementioned disadvantages.

### DESCRIPTION OF THE INVENTION

According to a first aspect the present invention provides a neutral lanthanide(III) complex comprising at least one ligand, said ligand having a heterocyclic aromatic ring with at least one carboxylic acid group attached thereto, wherein a heteroatom of the heterocyclic ring and the carboxylate function of the carboxylic acid group co-ordinate to the lanthanide.

It will be understood by those skilled in the art that the term neutral used in this context relates to the overall ionic charge on the lanthanide and its coordinated ligands. For example, the formal 3+ charge on the lanthanide is neutralized by providing in the ligands for the complex, three coordinating carboxylate groups, (RCO₂⁻) each of which contributes a negative charge to the overall charge of the complex.

Preferably the heteroatom coordinated to the lanthanide is nitrogen, oxygen, sulfur or phosphorus. Most preferably the heteroatom is nitrogen.

The heterocyclic aromatic ring may be five or six membered and may contain one or more heteroatoms. The ring may be further substituted, in addition to the substituent comprising the carboxylic acid group, and may be fused to other substituted or unsubstituted aromatic or non-aromatic ring systems. Substituents may include halogen, saturated or unsaturated aliphatic, or aromatic groups or substituted derivatives thereof. Preferably the heterocyclic aromatic ring is a substituted or unsubstituted pyridine ring.

Preferably the carboxylic acid group is directly bonded to the heterocyclic aromatic ring. Alternatively a linking group may attach it to the heterocyclic ring. For example the linking group may be a saturated or unsaturated aliphatic chain.

Preferably the carboxylic acid group is directly bonded ortho to the heteroatom of the heterocyclic aromatic group that coordinates to the lanthanide. More preferably the heterocyclic aromatic group has two carboxylic acid groups each ortho to the heteroatom, which coordinates to the lanthanide.

Preferably the ligand comprises two carboxylic acid groups. The ligand is therefore tridentate (at least) with the heteroatom of the heterocyclic ring and the two carboxylic acid groups available for co-ordination to the lanthanide.

Particularly preferred ligands (see scheme 1, below) include pyridine-2,5-dicarboxylic acid (2,5-DPA), 2,2′-bipyridine-5,5′-dicarboxylic acid (5,5′-BDPA), pyridine-2,6-dicarboxylic acid (2,6-DPA) and substituted derivates thereof. Substituents may include halogen, saturated or unsaturated aliphatic, or aromatic groups or substituted derivatives thereof. The pyridine ring may include additional heteroatoms and other substituted or unsubstituted aromatic or non-aromatic rings may be fused to the pyridine rings. Similar structures where the ring nitrogen atoms replaced by alternative heteroatoms (O,S,P) may also be used.

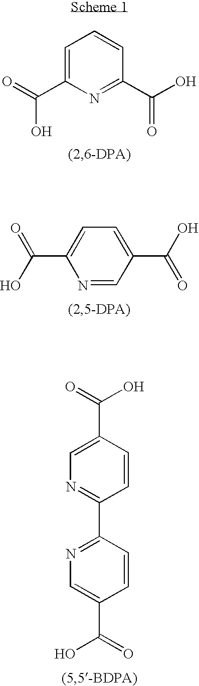

The ligands shown in Scheme 1 (and their substituted derivatives or derivatives where the nitrogen atom is replaced by an alternative heteroatom) are tridentate in use, having the ring nitrogen and an oxygen from each of the carboxylic acid groups co-ordinated to the lanthanide ion.

Some charged (i.e. not neutral) lanthanide complexes comprising ligands of the type shown in Scheme 1 are known, for example [Ln(2,6-DPA)₃]³⁻ in compounds such as Na₃[Ln(2,6-dpa)₃]×nH₂O (see ref. 4); dpa=dianion of DPA; Hdpa=monoanion of DPA. The complex is ionic in nature, [Ln(2,6-dpa)₃[³⁻ is charged because of deprotonation of both carboxylic acid functions on each of the DPA ligands and so the counter ions (Na⁺) are required. This leads to low luminescence behavior. In contrast complexes of the present invention, having an organic cation with a H-bond donor, tend to be stable and to exhibit high levels of luminescence, as discussed hereafter with respect to some preferred embodiments.

In general the majority of lanthanide complexes known tend to exhibit quite low luminescence and have poor stability. Preferably the complexes of the invention do not comprise water molecules i.e. they are anhydrous. The presence of water in a lanthanide complex is known to cause efficient deactivation of excited states e.g. ⁵D₀ (Europium(III)) and ⁵D₄ (Terbium(III)).

Any lanthanide element in the 3+ (III) state maybe employed in the luminescent complexes of the invention, europium, terbium and thulium are preferred.

Particularly preferred complexes of the invention are of the form [Ln(L)₃].3X where Ln is a lanthanide ion in the +3 state, the groups L are tridentate ligands of the form shown in Scheme 1, or the related derivatives discussed above and the groups X are hydrogen bonding groups, capable of hydrogen bonding to protons of the carboxylic acid groups of the ligands. Suitable groups X include aliphatic amines, for example dimethylamine. Examples of these preferred forms of the complex include [Ln(2,6-Hdpa)₃].3(CH₃)₂NH. Each original 2,6-DPA ligand has a deprotonated carboxylic acid group and the complex has the form shown in Scheme 2 below for the europium complex. (The three associated dimethylamine groups are not shown in this Scheme, for clarity; they can be cationic when the hydrogen ion of each Hdpa has moved to the amine.)

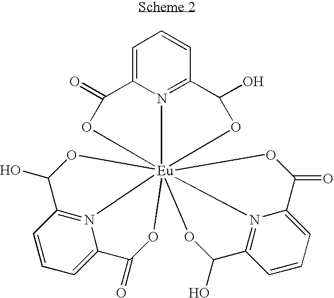

The ligands balance the +3 charge of the lanthanide(III ion to form a neutral complex. The dimethylamine groups are believed to stabilise the complex by hydrogen bonding to the remaining carboxylic acid protons on the ligands as suggested by the crystal structure which is shown in FIG. 1 for the europium complex [Eu(2,6-Hdpa)₃].3(CH₃)₂NH, or alternative formulated as ((CH₃)₂NH₂)₃[Eu(2,6-dpa)₃].

The lanthanide complexes of the invention can be formed by the techniques well known to those skilled in the art of rare earth chemistry. Complexes of the form [Ln(L)₃].3(CH₃)₂NH can be readily produced by the new method of the invention.

Thus, according to a second aspect, there is provided a method of synthesizing a lanthanide complex comprising at least one ligand, said ligand having a heterocyclic aromatic ring with at least one carboxylic acid group attached thereto, wherein a heteroatom of the heterocyclic rings and the carboxylate function of the carboxylic acid group co-ordinate (chelate) to the lanthanide, the method comprising the step of heating a mixture of a lanthanide 3+ salt and ligand L in a suitable solvent until a precipitate of said lanthanide complex forms.

Thus in accordance with the second aspect the present invention provides in a preferred embodiment a method of synthesizing a lanthanide complex of the form [Ln(L)₃].3(CH₃)₂NH (or other amine) where the groups Ln, L have the same meaning as before, comprising the step of heating a mixture of a lanthanide 3+ salt and a ligand L in dimethylformamide until a precipitate of [Ln(L)₃].3(CH₃)₂NH forms.

The preparation method described above consists of a simple, essentially one-step synthesis, with high yield (typically >80%). It is particularly suitable for large-scale production.

Preferably the lanthanide 3+ salt and the ligand L are dissolved in the dimethylformamide before heating the resultant solution.

The lanthanide salt may be of any type, the chloride (LnCl₃), for example EuCl₃, TbCl₃ or TmCl₃, is preferred.

The precipitated complex can then by filtered off and dried by any suitable means. The dimethylamine groups found in the products are formed by degradation of the dimethylformamide (DMF) solvent. If an alternative to the dimethylamine hydrogen-bonding group is desired the method of the invention may be modified to include the addition of a suitable compound X to the reaction mixture, for example another amine, such as diethylamine may be added to the mixture. Alternative solvents may be employed to avoid incorporation of dimethylamine derived from the DMF.

Products of the synthetic method are generally highly crystalline white powders, which are insensitive to air, water and other organic solvents, such as alcohols, ethers, and toluene for example.

The complexes of the invention exhibit strong luminescence at particular wavelengths depending on the lanthanide ion and the ligands employed. Thus a given complex will show a particular luminescence colour. Thus, it is also possible to form mixed complexes of the lanthanide complexes according to the present invention. By combining two (or more) complexes, mechanically mixing them together, the colour of luminescence may be adjusted, but precise control on homogeneous mixing the two different solid materials can be difficult. However, a highly accurate and predictable result can be achieved by other means, as mentioned below.

Thus the present invention provides in a preferred embodiment a method for the preparation of a mixed complex of the form [Ln¹(L)₃].3(CH₃)₂NH:[Ln²(L)₃].3(CH₃)₂NH:Ln³(L)₃].3(CH₃)₂NH (etc.) of the invention where Ln¹, Ln² and Ln³ (etc.) are different lanthanides and L has the same meaning as before comprising the step of heating a mixture of Ln¹ and Ln² 3+ salts, in a selected ratio, and a ligand L in dimethylformamide until a precipitate of [Ln¹(L)₃].3(CH₃)₂NH:[Ln²(L)₃].3(CH₃)₂NH forms. As with the method for producing the complexes with only one lanthanide element present, the mixed element complexes, can be prepared with different hydrogen bonding groups if desired by addition of the selected compound to the reaction mixture.

The mixed complex contains two (independent) activators, thus emitting different colors. Since the relative concentrations of activators is adjustable at the atomic level, the desired color, for example, between green and red can readily be obtained more easily than by attempting to mix two separately produced complexes. A similar approach can be taken when making other complexes of the invention by alternative synthetic methods.

A further important benefit of the invention is that the lanthanides can be easily recycled, reducing the costs and the usage of the lanthanides employed. Therefore, the luminescent lanthanide complexes of the invention can be considered environmentally friendly materials.

The luminescent lanthanide complexes of the invention can exhibit high levels of absorption when subjected to ultraviolet light, exceeding 95% at 254 nm. They can equally show intense emission, with quantum efficiency above 70%. Combined with their stability these properties make them ideal candidates for lighting applications, particularly but not exclusively as components in the so called tricolour lamps discussed above.

Thus according to a fourth aspect the present invention provides a luminescent lamp wherein at least part of the luminescence is provided by a neutral lanthanide(III complex comprising at least one ligand, said ligand having a heterocyclic aromatic ring with at least one carboxylic acid group attached thereto, wherein a heteroatom of the heterocyclic ring and the carboxylate function of the carboxylic acid group both co-ordinate to the lanthanide.

Preferably the lanthanide complex of the luminescent lamp is of the form [Ln(L)₃].3X wherein Ln, L and X have the same meaning as before. Most preferably the lanthanide complex of the luminescent lamp is of the form [Ln¹(L)₃].3(CH₃)₂NH.

The complexes of the invention can find use in other applications where luminescence is required. Thus according to a fifth aspect the present invention provides a luminescent display wherein at least part of the luminescence is provided by a neutral lanthanide(III) complex comprising at least one ligand, said ligand having a heterocyclic aromatic ring with at least one carboxylic acid group attached thereto, wherein a heteroatom of the heterocyclic ring and the carboxylate function of the carboxylic acid group co-ordinate to the lanthanide. The display may be, for example, an OLED (organic light emitting diode) display with the lanthanide complex or complexes forming part of the emitting layers.

### BRIEF DESCRIPTION OF THE DRAWINGS

Further preferred features and advantages of the present invention will appear from the following detailed description of some embodiments illustrated with reference to the accompanying drawings in which:

FIG. 1 shows the crystal structure of a europium complex of the invention;

FIG. 2 shows x-ray powder diffraction results for complexes of the invention;

FIG. 3 shows the emission spectrum of a complex of the invention; and,

FIG. 4 shows the emission spectrum of another complex of the invention.

### DESCRIPTION SOME PREFERRED EMBODIMENTS AND EXPERIMENTAL RESULTS

### EXAMPLE 1

### Eu(III) complex

The complex [Eu(2,6-Hdpa)₃].3(CH₃)₂NH was prepared as follows:

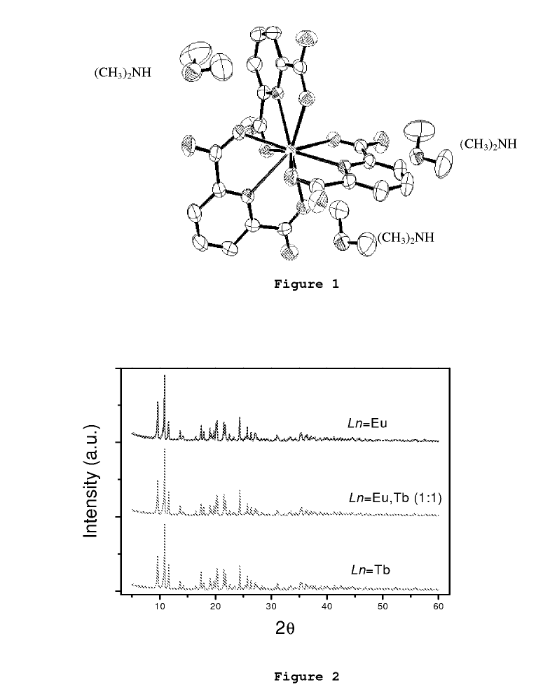

1.2 g of EuCl₃.6H₂O was dissolved in 50 ml dimethylformamide (DMF) to produce a 0.033 M solution. The solution was transferred into a 100 ml round-bottomed flask, and 3 equivalents of Pyridine-2,6-dicarboxylic acid (2,6-DPA=H₂dpa) (1.65 g) in 50 ml DMF (generating a 0.1 M solution) was added to form a 0.1 M DMF solution. The mixture was heated under reflux (about 153° C.) for at least one hour, during which a white crystalline precipitate was formed. The product was filtered under reduced pressure (büchner), washed 3× with diethyl ether and dried in an oven at 100° C. It shows an intense red emission when irradiated by 254 nm UV radiation. The crystal structure of the complex is shown in FIG. 1, with the hydrogen atoms omitted for clarity. The europium ion is coordinated at the ring nitrogen and both carboxylic acid groups of each 2,6-DPA ligand. The three dimethylamine groups, labelled as (CH₃)₂NH, are not directly coordinated to the europium, but provide hydrogen bonding interaction with the acid groups.

### EXAMPLES 2 AND 3

### Tb(III) complex and a mixed Eu(III) and Tb(III) complex

The same procedure as above for Example 1 was used for the production of [Tb(2,6-Hdpa)₃].3(CH₃)₂NH (Example 2), starting from TbCl₃.

A complex containing a 1:1 mixture of [Tb(2,6-Hdpa)₃].3(CH₃)₂NH:[Eu(2,6-Hdpa)₃- 3(CH₃)₂NH was prepared as Example 3 in a similar fashion, using a 1:1 mixture of the lanthanide chloride salts.

### Results

FIG. 2 shows the X-ray powder diffraction patterns of the three example compounds.

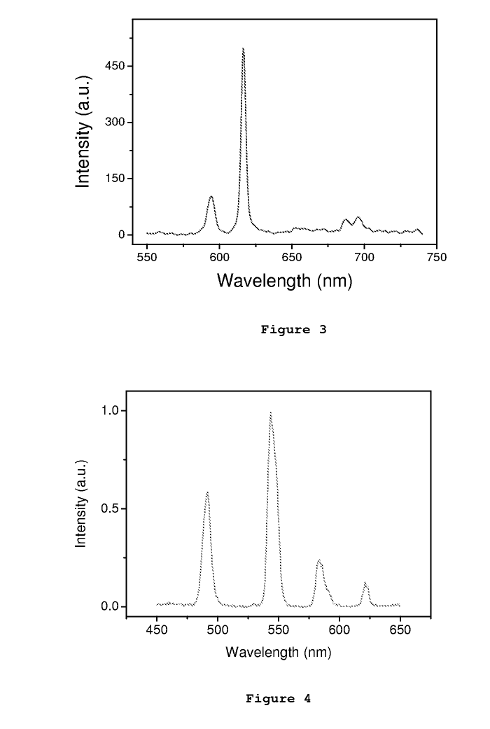

On excitation with UV light the complexes with Ln=Eu(III) and Ln=Tb(III) (examples 1 and 2) respectively show very intense red and green emission (FIG. 3 and FIG. 4). The quantum efficiency is above about 70%. The emission of the Eu(III) (example 1) is dominated by the line at λ=615 nm, which is highly suitable for the requirements of a red ‘phosphor’ (luminescent material) in practical applications.

The Tb(III) complex of example 2 emits a green light, which in 1:1 combination (example 3) with the Eu(III) complex of example 1 produces a yellow/orange emitting mixture. The color of such a mixture can easily be adjusted by altering the ratio of Eu to Tb salt added to the reaction mixture during the synthesis.

### References

1. R. M. Leskela, Rare earth Spectroscopy, World Scientific, 1985.
2. G. Blasse and B. C. Grabmeier, Luminescent materials, 1^{st} ed., Springer, Berlin, 1994.
3. T. Justel, H. Nikol and C. Ronda, Angew. Chem. Int. ed., 37, 3085 (1998).
4. G. M. Murray, R. V. Sarrio, J. R. Peterson, Inorg. Chim. Acta, 176, 233 (1990).

1. A neutral lanthanide(III) complex comprising at least one ligand, said ligand having a heterocyclic aromatic ring with at least one carboxylic acid group attached thereto, wherein a heteroatom of the heterocyclic ring and the carboxylate function of the carboxylic acid group co-ordinate (chelate) to the lanthanide.

2. A luminescent lamp wherein at least part of the luminescence is provided by a neutral lanthanide(III) complex comprising at least one ligand, said ligand having a heterocyclic aromatic ring with at least one carboxylic acid group attached thereto, wherein a heteroatom of the heterocyclic ring and the carboxylate function of the carboxylic acid group co-ordinate (chelate) to the lanthanide.

3. A luminescent display wherein at least part of the luminescence is provided by a neutral lanthanide(III) complex comprising at least one ligand, said ligand having a heterocyclic aromatic ring with at least one carboxylic acid group attached thereto, wherein a heteroatom of the heterocyclic ring and the carboxylate function of the carboxylic acid group co-ordinate (chelate) to the lanthanide.

4. A method of synthesizing a lanthanide complex comprising at least one ligand, said ligand having a heterocyclic aromatic ring with at least one carboxylic acid group attached thereto, wherein a heteroatom of the heterocyclic rings and the carboxylate function of the carboxylic acid group co-ordinate (chelate) to the lanthanide, the method comprising the step of heating a mixture of a lanthanide 3+ salt and ligand L in a suitable solvent until a precipitate of said lanthanide complex forms.

5. The method according to claim 4 wherein a mixture of lanthanide (III) complexes are formed from a mixture of 2 or more different Ln salts.
